(19) United States
(12) Patent Application Publication
(10) Pub. No.: US 2025/0298579 A1
(43) Pub. Date: Sep. 25, 2025

(54) User-Interface Navigator

(71) Applicant: Google LLC, Mountain View, CA (US)

(72) Inventor: Dongeek Shin, San Jose, CA (US)

(73) Assignee: Google LLC, Mountain View, CA (US)

(21) Appl. No.: 19/228,130

(22) Filed: Jun. 4, 2025

(51) Int. Cl. G06F 3/16; G06F 3/03; G06F 40/284; G06F 40/30

(52) U.S. Cl. CPC G06F 3/167; G06F 3/0312; G06F 40/284; G06F 40/30

(57) ABSTRACT

The present document describes techniques for a user-interface (UI) navigator. The UI navigator can provide a framework that combines large action models (LAMs) with a shallow-depth UI framework to one-shot travel to a user-intended destination within the UI framework. The input can be any combination of a user speech, text, and/or a device-interaction input (e.g., rotary dial, button press, touch gesture). The UI navigator infers user intent from the input(s), using the LAM, which is constrained to the UI framework. The output can be a graphical user interface (GUI) responding to (e.g., operating according to) the user intent.

### SUMMARY

The present document describes techniques for a user-interface (UI) navigator. The UI navigator can provide a framework that combines large action models (LAMs) with a shallow-depth UI framework to one-shot navigation to a user-intended destination within the UI framework. The input can be any combination of a user speech, text, and/or a device-interaction input (e.g., rotary dial, button press, touch gesture). The UI navigator infers user intent from the input(s), using the LAM, which is constrained to the UI framework. The output can be a graphical user interface (GUI) responding to (e.g., operating according to) the inferred user intent.

In aspects, a method is disclosed. The method includes receiving a user input at a device having an output-token space including a plurality of node tokens, each node token being associated with a UI state of a UI framework and an intended device behavior corresponding to the UI state. The method also includes encoding the user input into a decoder-input token space to provide a encoded user input. In addition, the method includes receiving a device-interaction input and converting, by a trained input encoder, the device-interaction input into a valid token. The method also includes selecting a node from the output-token space based on a combination of the valid token and the encoded user input. Also, the method includes providing an output corresponding to the selected node token, the output including a one-shot navigation to a UI state represented by the selected node token. In some aspects, a function corresponding to the UI state can automatically be executed.

This summary is provided to introduce simplified concepts of a UI navigator, which is further described below in the Detailed Description. This summary is not intended to identify essential features of the claimed subject matter, nor is it intended for use in determining the scope of the claimed subject matter.

### BRIEF DESCRIPTION OF DRAWINGS

The details of one or more aspects of a user-interface (UI) navigator are described in this document with reference to the following drawings. The same numbers are used throughout the drawings to reference like features and components:

FIG. 1 illustrates an example implementation of a computing device configured for a UI-framework navigator in accordance with the techniques described herein;

FIG. 2 illustrates an example implementation of the computing device from FIG. 1 in more detail;

FIG. 3 illustrates an example implementation of a UI framework for the computing device in FIG. 1;

FIG. 4 illustrates an example implementation of an UI framework of the computing device from FIG. 1;

FIG. 5 illustrates an example pipeline of the UI navigator in accordance with one or more implementations;

FIG. 6 illustrates a trainer by which to train an LAM used for providing a one-shot navigation to a user-intended destination within a UI framework in accordance with one or more implementations;

FIG. 7 illustrates an example transformation in a language space of an input tensor component; and

FIG. 8 depicts an example method for implementing aspects of a UI navigator in accordance with one or more implementations.

### DETAILED DESCRIPTION

### Overview

Many devices have become mainstream in combining human-sensing intelligence with anticipatory controls for, for example, the home. However, some such devices have graphical user interface (GUI) limitations, which can result in low feature discoverability and be challenging to use in many aspects. For example, a device having a shallow-depth user interface (UI) framework includes a small number of actions (e.g., less than five) under each node but further nested actions are unavailable. Framework-wise, such a shallow-depth UI framework is very different from a mobile phone UI framework, which has a breadth of applications with deep navigation and many steps. Accordingly, GUI navigation in devices having a shallow-depth UI framework can be cumbersome and challenging for some users, resulting in a poor user experience.

The present document describes a UI navigator. The UI navigator is implemented in a shallow-depth UI framework. In aspects, the UI navigator can receive a user input, such as a voice command, text input, and/or a device-interaction input, infer a user intent from the input(s) by using a large action model, and provide a one-shot navigation to a particular UI state corresponding to the inferred user intent. The large action model is constrained based on UI states within the UI framework, such that the output of the large action model is limited to the UI states and their functions or a null state. Accordingly, the one-shot navigation refers to a one-time execution of logic to generate a UI state from an inferred user intent.

In one example implementation, a computing device, such as a thermostat, is inactive and a user provides a voice command by saying “Turn up the temperature by two degrees.” The thermostat, using the UI navigator, displays a UI showing a temperature setting increasing by two degrees, such as by displaying a dial turning digitally. In another example, the user says to the thermostat, “Hey, my fan is not turning on. What's going on?” The thermostat then infers the user's intent and accesses an article via a network (e.g., Internet) or data in local memory to search for a solution. Based on the information found in the article or data, the thermostat accesses and displays a particular settings page having a particular setting that can be adjusted or toggled to fix the fan.

In another example, the user provides a voice command and also turns the dial on the thermostat to provide an additional signal relative to the user's intent. In this case, the voice command is understood by the thermostat but the act of turning the dial toward a particular page/category (e.g., settings) provides a device-interaction input that represents an additional probability weight toward a particular subpage within the page/category (e.g., a settings page) in the final UI estimation. In this way, the additional probability weight indicates a higher likelihood that the user intent is related to the particular page/category. Accordingly, this dual input of voice (or text) plus a device-interaction input (e.g., physical input) can significantly increase the accuracy of the output as it relates to the user intent.

While features and concepts of the described techniques for a UI navigator can be implemented in any number of different environments, aspects are described in the context of the following examples.

### Example System and Devices

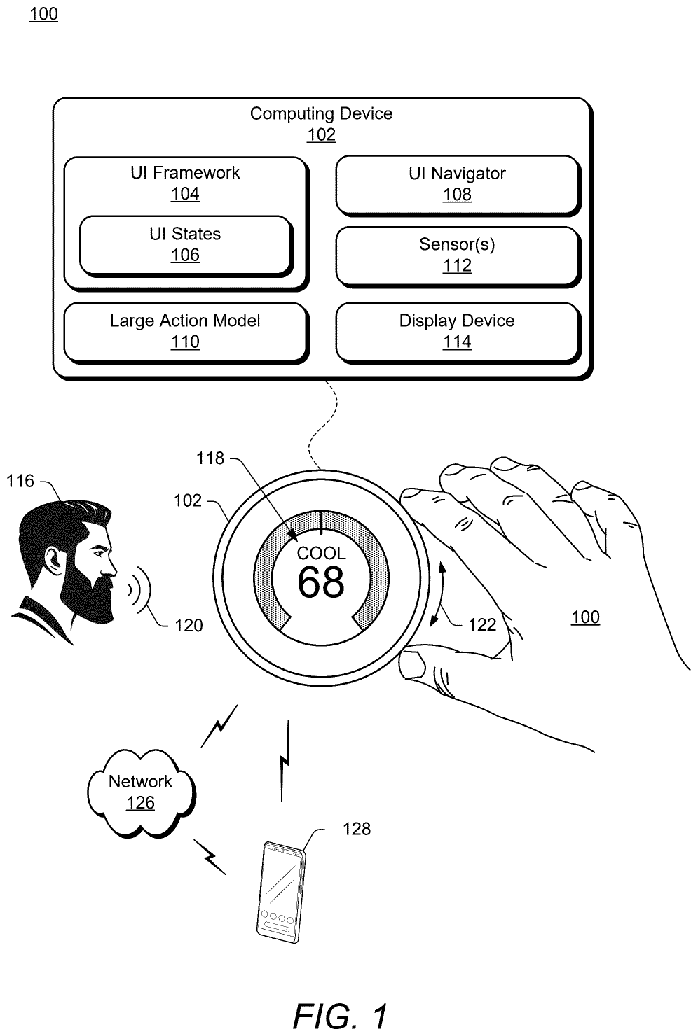

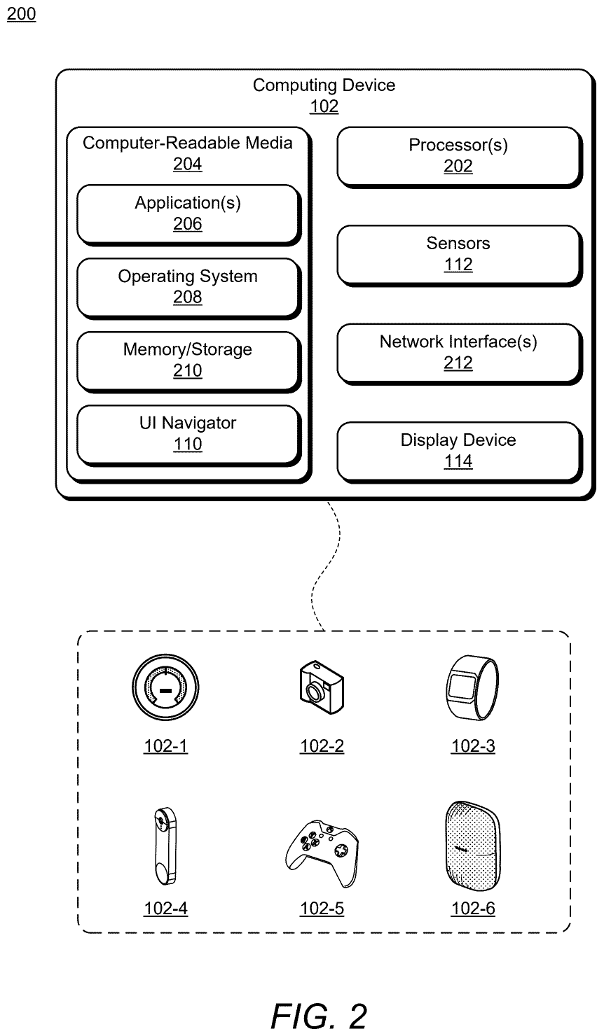

FIG. 1 illustrates an example implementation 100 of a computing device configured for a UI-framework navigator in accordance with the techniques described herein. The illustrated example includes a computing device 102 having various components operable to implement a UI-framework navigator. For example, the computing device 102 can include a UI framework 104 having a plurality of UI states 106. The computing device 102 can also include a UI navigator 108, a large action model (LAM) 110, one or more sensors 112, and a display device 114. Additional components necessary to enable operation of a computing device are also included in the computing device 102 and some such components are described with respect to FIG. 2.

The UI framework 104 defines a structure for defining user interfaces. The UI framework 104 includes a set of classes and interfaces that define elements and behaviors of a window-based UI subsystem. The UI state refers to the appearance and behavior of a UI component or UI page at a particular moment. The UI state is a visual representation of the application's data and logic, providing feedback to a user 116 via the display device 114 about a current status. In the example illustrated in FIG. 1, the computing device 102 is a digital thermostat displaying an example UI state 118, which indicates that an heating, ventilation, and air conditioning (HVAC) system is set to cool the temperature to 68 degrees (Fahrenheit). In aspects, the UI framework 104 of the computing device 102 includes an exhaustive list of UI destinations and UI pages (e.g., less than 100, less than 50) and can thus be referred to as a shallow-depth UI framework. In contrast, deep, rich UI frameworks can have UI destinations and UI pages in the hundreds or thousands.

The UI navigator 108 is configured to utilize the LAM 110 to determine a user intent from a user input and translate the user intent into an action within a given environment or system, such as the UI framework 104. In contrast to a large language model (LLM), which outputs text, the output of the LAM is a concrete action or a concrete UI state. By utilizing the LAM 110, the UI navigator 108 enables the computing device 102 to provide an agentic experience to the user. In implementations, the UI navigator 108 provides a one-shot travel to a user-intended destination within the UI framework.

The sensor(s) 112 can be any suitable sensor for detecting and/or receiving a user input. Example sensors 112 are described with respect to FIG. 2. The sensor 112 is configured to detect a user input. In one example, the user input includes a voice input 120 by the user 116. In aspects, the user 116 can interact with an actuator to provide an actuator input 122, such as by turning a rotary dial with their hand 124, pressing a button, etc. In yet another example, the user input includes a touch input (not shown), such as a touch gesture (e.g., tap, drag, swipe, double-tap, multi-finger touch) via the display device 114. In some implementations, the user input can be a communication received via a network 126 from another device. For example, the user 116 can provide the user input via a mobile application on a mobile phone 128 that is configured to remotely control and manage the computing device 102. The mobile phone 128 can wirelessly communicate the user input via the network 126 (e.g., cellular, Wi-Fi) or via a direct, short-range wireless communication link (e.g., Bluetooth™).

Consider now FIG. 2, which illustrates an example implementation of the computing device 102 from FIG. 1 in more detail. The computing device 102 of FIG. 2 is illustrated with a variety of example devices, including a thermostat 102-1, a digital camera 102-2, a computing watch 102-3, a video-recording doorbell 102-4, a gaming controller 102-5, computing spectacles 102-6, and a speaker 102-9. The computing device 102 can also include other devices, e.g., computing spectacles, audio systems, projectors, drones, drawing pads, e-readers, and home appliances. Note that the computing device 102 can be mobile, wearable, non-wearable but mobile, or relatively immobile (e.g., a thermostat).

The computing device 102 includes one or more processors 202 (e.g., any of microprocessors, microcontrollers, or other controllers) that can process various computer-executable instructions to control operation of the computing device 102 and to enable techniques for a UI-framework navigator. Alternatively or additionally, the processor(s) 202 can be implemented with any one or combination of hardware elements, firmware, or fixed logic circuitry that is implemented in connection with processing and control circuits. The processor(s) 202 can include, as non-limiting examples, a system-on-a-chip (SoC), an application processor (AP), a central processing unit (CPU), or a graphics processing unit (GPU). The processor(s) 202 generally execute commands and processes utilized by the computing device 102 and an operating system installed thereon. For example, the processor(s) 202 can perform operations to display graphics of the computing device 102 on the display device 114 and can perform other specific computational tasks, such as controlling the creation and display of an image on the display device 114.

The computing device 102 also includes computer-readable media 204 (CRM 204) that provides storage for various applications 206 and system data. Applications 206 and/or an operating system 208 implemented as computer-readable instructions on the CRM 204 (e.g., the storage media) can be executed by the processor(s) 202 to provide some or all of the functionalities described herein. The computer-readable media 204 provides data storage mechanisms to store various device applications 206, the operating system 208, memory/storage 210, and other types of information and/or data related to operational aspects of the computing device 102. In an example, the operating system 208 can be maintained as a computer application within the computer-readable media 204 and executed by the processor(s) 202 to provide some or all of the functionalities described herein. The device applications 206 may include a device manager, such as any form of a control application, a software application, or signal-processing and control modules (e.g., the UI navigator 108). The computing device 102 may also include, or have access to, one or more machine learning systems. The memory/storage 210 is a suitable storage device (e.g., random-access memory (RAM), static RAM (SRAM), dynamic RAM (DRAM), non-volatile RAM (NVRAM), read-only memory (ROM), flash memory) configured to store device data of the computing device 102, user data, and multimedia data. The memory/storage 210 can store data at least partially representing the LAM 110, such that the LAM 110 is stored and executed “on-device” (e.g., on the computing device 102). In some examples, the LAM 110 may be partially represented by data stored on devices external to the device (e.g., a server) but in network communication with the device (e.g., via the network 126). In another example, the LAM 110 is represented by a combination of data stored on the computing device (e.g., in the memory/storage 210) and on one or more devices external to the device (e.g., a server) but in network communication with the device (e.g., via the network 126).

The computing device 102 may also include a network interface 212. The computing device 102 can use the network interface 212 for communicating data over a network (e.g., the network 126), which may be a wired, a wireless, an optical, or an audio (e.g., acoustic) network. By way of example and not limitation, the network interface 212 may communicate data over a local-area network (LAN), a wireless local-area network (WLAN), a HAN, a personal-area network (PAN), a wide-area network (WAN), an intranet, the Internet, a peer-to-peer network, point-to-point network, or a mesh network. The network interface 212 can be implemented as one or more of a serial and/or parallel interface, a wireless interface, any type of network interface, a modem, or any other type of communication interface. Using the network interface 212, the computing device 102 may communicate via a cloud computing service to access a platform having resources.

The computing device 102 also includes one or more sensors 112, which can include any of a variety of sensors, including an audio sensor (e.g., a microphone), a touch-input sensor (e.g., a touchscreen, a fingerprint sensor, a capacitive touch sensor), an image-capture device (e.g., a camera or video camera), a proximity sensor (e.g., capacitive sensor), a motion-detection sensor (e.g., passive infrared sensor), etc.

The display device 114 can include any suitable display device, e.g., a touchscreen, a liquid crystal display (LCD), thin-film transistor (TFT) LCD, an in-place switching (IPS) LCD, a capacitive touchscreen display, an organic light-emitting diode (OLED) display, an active-matrix organic light-emitting diode (AMOLED) display, super AMOLED display, and so forth. The display device 114 may be referred to as a display or a screen, such that digital content may be displayed on-screen.

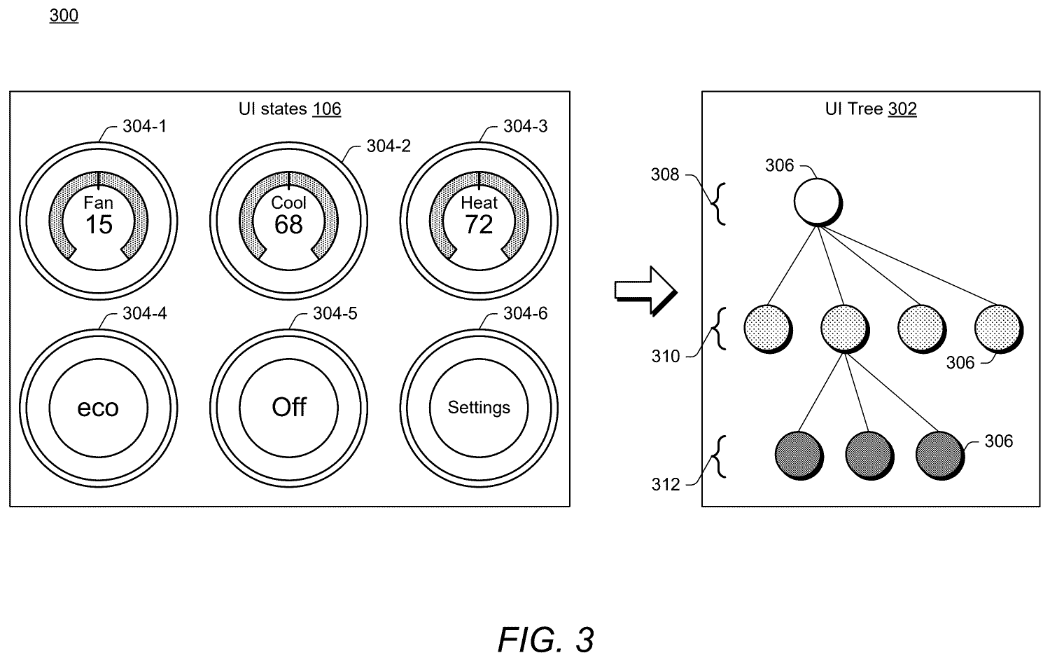

FIG. 3 illustrates an example implementation 300 of a UI framework for the computing device 102 in FIG. 1. For example, the UI framework 104 includes a plurality of UI states 106 that are represented in a UI tree 302. The UI states 106 include a plurality of UI screenshots 304 associated with intended device behavior. Some examples of UI screenshots 304 include a fan state 304-1, a cool state 304-2, a heat state 304-3, an eco-state 304-4, an off state 304-5, and a settings state 304-6. These UI screenshots are examples only and not intended to be limiting. Any suitable UI screenshot can be implemented for each unique UI state 106. At least some of the UI states 106 have dependencies. However, in a shallow-depth UI framework, only a few depths are utilized. For example, the computing device 102 may have five or fewer depths.

The UI tree 302 in the illustrated example includes nodes 306 arranged in three depths, such as a top level 308, a first depth 310, and a second depth 312. Each node 306 represents one of the UI states 106. The first depth 310 is accessed via the top level 308. The second depth 312 is accessed via the first depth 310. In aspects, the UI navigator 108 can crawl through the UI framework 104 and the UI states 106 and reconstruct the UI tree 302.

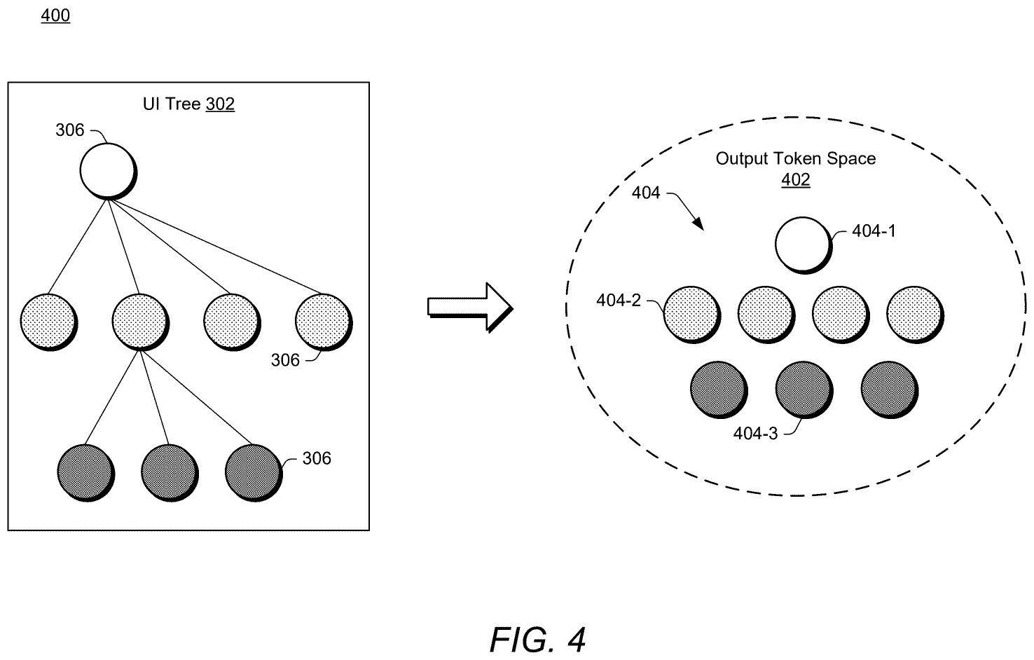

Continuing in FIG. 4, an example implementation of an UI framework of the computing device 102 from FIG. 1 is illustrated. The UI navigator 108 can transform the UI tree into an output-token space 402. For example, the UI navigator 108 can equalize each node 306 in the UI tree 302 by converting the node 306 into a node token 404. The node tokens 404 each represent a node 306 and include a pairing a UI screenshot of the UI state 106 and a description of the corresponding behavior (e.g., end state) of the UI state 106.

Note that this transformation of the nodes 306 into node tokens 404 removes the depth-specific characteristic of the nodes 306 in the UI tree 302 and instead provides a depth dependency (e.g., depth-N) to each node token 404. For example, a depth-0 token (e.g., node token 404-1) is assigned a depth dependency of zero (0) and thus precedes a depth-1 token (e.g., node token 404-2) having a depth dependency of one (1), which in turn precedes a depth-2 token (e.g., node token 404-3) having a depth dependency of two (2). The bundle of node tokens form the output-token space 402 of the UI navigator 108.

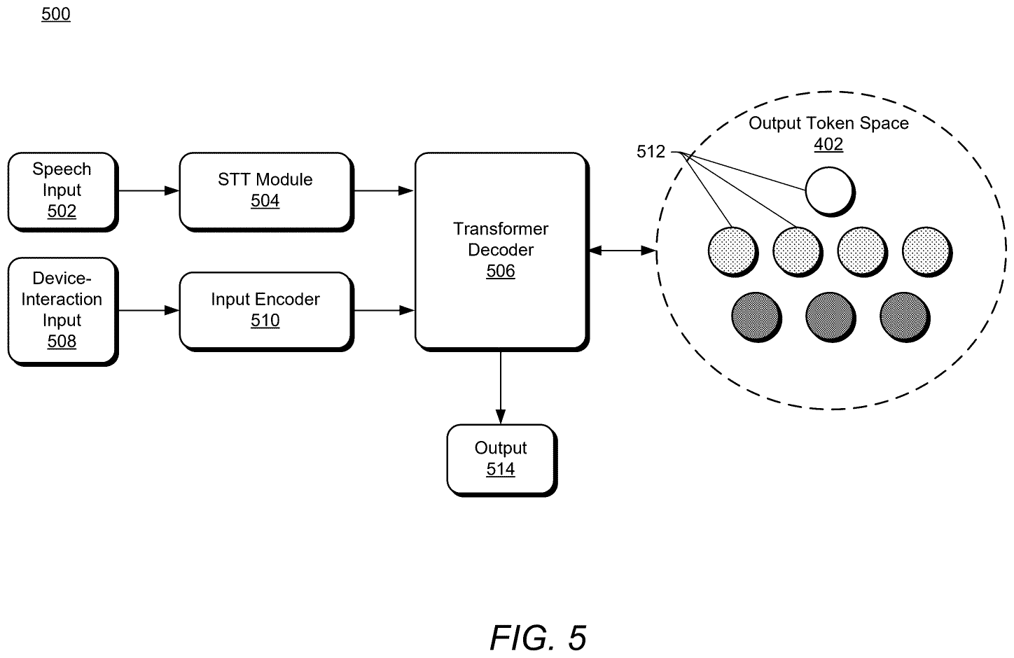

In aspects, the output-token space 402 can be enforced by constrained decoding, such that the LAM 110 is constrained to output a UI state represented by one of the node tokens 404. An example of this is described with respect to FIG. 5.

FIG. 5 illustrates an example pipeline 500 of the UI navigator in accordance with one or more implementations. In an example, a speech input 502 is received by the computing device 102. For example, the speech input 502 is voice input received via the sensors 112 (e.g., a microphone). In another example, the speech input 502 is text received from another device, such as via a mobile application on the mobile phone 128.

The computing device includes a speech-to-text (STT) module 504 and a transformer decoder 506. The transformer decoder 506 is a representation of the LAM 110. The speech input 502 is encoded into a decoder-input token space and tokenized by the STT module 504 to provide an encoded user input. Additionally or alternatively, a device-interaction input 508 is received by the computing device 102. The computing device 102 includes an input encoder 510. The input encoder 510 can be trained using any suitable technique, including those likely known in the art, such as techniques for training a transformer-based encoder, a recurrent neural network (RNN)/convolutional neural network (CNN) based-transformer, etc. The input encoder 510 can be trained to encode signals received via the device-interaction input 508 into tokens usable by the transformer decoder 506. Accordingly, the input encoder 510 used by the computing device 102 is a trained input encoder 510. The device-interaction input 508 includes any suitable user interaction with an input mechanism of the computing device 102, such as a rotary dial, a touch screen, a button, a switch, and so forth. The device-interaction input 508 is converted into a valid token by the input encoder 510.

The transformer decoder 506 receives, as input, the outputs (e.g., token(s)) of the STT module 504 and/or the input encoder 510. The output-token space 402 is used as context input for the transformer decoder 506 with constrained decoding. In this way, the transformer decoder 506 is constrained to output one of the end states within the output-token space 402. Using these inputs along with the constrained decoding associated with the output-token space 402, the transformer decoder 506 can infer a user intent. For example, the transformer decoder 506 determines which node token 512 most closely corresponds to the user intent based on the inputs. The transformer decoder 506 then selects that node token 512 and provides an output 514. The output 514 is a one-shot navigation to the UI state 106 corresponding to the selected node token. Accordingly, the “one-shot” navigation is based on execution of the transformer decoder 506 (e.g., the LAM 110). In some implementations, the output 514 is used by the UI navigator 108 to cause the computing device 102 to perform a function of the UI state 106 corresponding to the selected node token.

In some implementations, one of the end states can include a null state. For example, the transformer decoder 506 may not have a high confidence in directly taking an action. Thus, the output 514 can include a null state, which can trigger the LAM 110 to enter a text mode or a voice mode to generate a prompt to request clarification or additional information from the user regarding the user intent. For example, the computing device 102 can ask the user a question, such as “is this what you meant?” or “can you repeat that?” The user can then provide an additional voice input or device-interaction input. Such additional input can enable the transformer decoder 506 to exit the null state and enter a valid state for the UI. Then, the computing device 102 can automatically select a new node token from the output-token space 402 and adjust the output to provide a function corresponding to that valid UI state. The transformer decoder 506 can use any suitable model backbone and be fine-tuned for the specific form factor and functionality of the computing device 102 to provide an agentic one-shot navigation.

The various entities of FIGS. 1-7 may be further divided, combined, used along with other sensors or components, and so on. In this way, different implementations of the computing device 102, with different configurations of the UI navigator 108 and the LAM 110, can be used to implement the UI navigator. The example implementation 100 of FIG. 1 and the detailed illustrations of FIGS. 2-7 illustrate but some of many possible environments and devices capable of employing the described techniques.

### Large Action Models (LAMs)

Generally, large action models (LAMs) are a class of artificial intelligence (AI). LAMs are trained on enormous amounts of data to provide foundational capabilities, which can be used and reused, often through fine-tuning for particular applications and tasks. Other software applications, in contrast, are often built and trained on specific data for each use case. In this way, LAMs are considered a type of foundational model. LAMs are similar to large language models (LLMs), but instead of outputting text, a LAM outputs a concrete action, such as a function of a UI state.

Some LAMs use a machine-learned (ML) model that can parse language and provide context-aware outputs, for example to execute a function associated a user intent. This output is a response to a user input, for example from a user asking a question. The user input may be a voice command saying “turn the fan down,” for example, and can be used as a prompt by which an LAM provides a UI state via display device that shows a fan setting being adjusted to decrease the fan speed, which in turn causes the fan speed to be correspondingly adjusted.

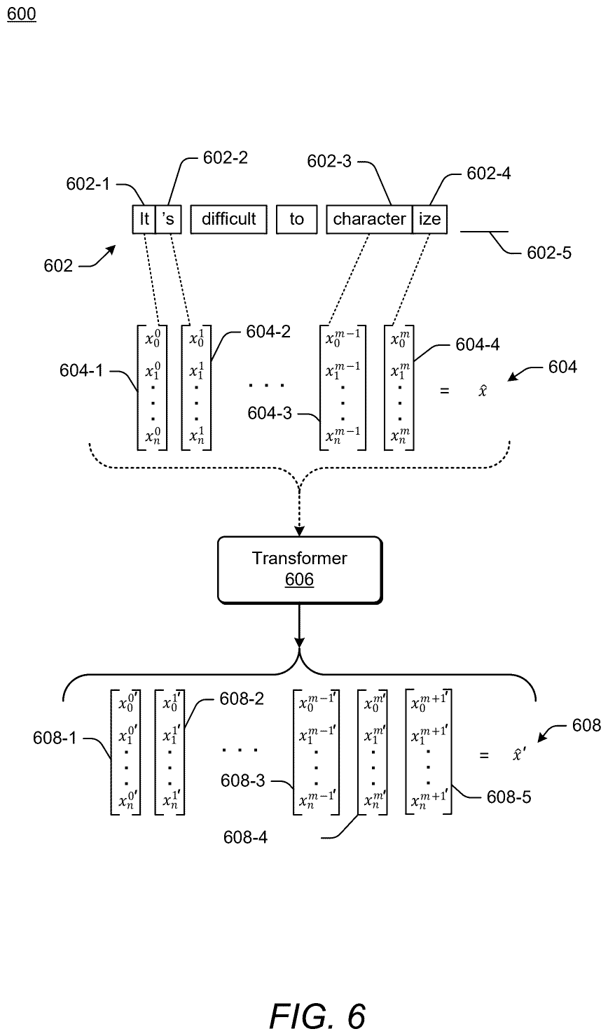

By way of example, consider FIG. 6, which illustrates a trainer 600 by which to train an LAM used for providing a one-shot navigation to a user-intended destination within a UI framework. The trainer 600 receives training data as training inputs, such as an input 602. This training data may be of many different types, such as voice, text, or actuator input. In the example illustrated by FIG. 6, the training input 602 is a phrase, though it may instead be a word, a long text passage (e.g., a book, article, or web-page), or any other data containing comprehensible text. In some examples, the text is from a screen or image capture. In a process called “tokenization,” the trainer 600 breaks the training input 602 into tokens, marked as tokens 602-1, 602-2, 602-3, and 602-4. Here the training input 602 has a missing next word, marked as a blank 602-5. The goal of the trainer 600 is to predict the blank 602-5.

The trainer 600 encodes the tokens (602-1, 602-2, etc.) into an input tensor \hat{x} 604 through a mapping procedure. For instance, the token “It” 602-1 is mapped to a first component 604-1 of the input tensor \hat{x} 604, the token “'s” is mapped to a second component 604-2 of the input tensor \hat{x} 604, the token “character” is mapped to a third component 604-3 of the input tensor \hat{x} 604, and the token “ize” is mapped to a fourth component 604-4 of the input tensor \hat{x} 604. Though the tokens “It” 604-1 and “'s” 604-2 are shown as two portions of the word “It's,” other mapping schemes exist, for example a mapping based on discrete words or phonemes. In some instances, an ML model or an ML component of the trainer 600 performs the tokenization and/or mapping of the training input 602 into the input tensor \hat{x} 604 (e.g., a feature-extracting convolutional neural network (CNN)). The mapping of the tokenized training input 602 into the input tensor \hat{x} 604 may involve a lookup table, which maps each possible token (e.g., 602-1, 602-2, etc.) to a known tensor object in a language space of the training data.

A transformer 606 takes the input tensor \hat{x} 604 as an input, with the goal of predicting the blank 602-5 by transforming the input tensor \hat{x} 604 into a transformed tensor \hat{x}′ 608. The transformation process is mathematically represented as follows:

$$T \hat{x} = {\hat{x}}^{′} \qquad Eq . 1$$

The T in Eq. 1 represents the transformer 606. The transformed tensor \hat{x}′ 608 includes components 608-1, 608-2, 608-3, 608-4, and 608-5. The component 608-1 is a transformation of the component 604-1 by the transformer 606 (similar for component pairs 608-2/604-2, 608-3/604-3, and 608-4/604-4). The component 608-5 corresponds to the blank 602-5, and thus the component 608-5 is a prediction for the blank 604-5. The final transformed tensor \hat{x}′ 608 component 608-5 is derived as part of the transformation process in addition to the contextualization of the components 604-1 through 604-4.

Inputs, e.g., the input tensor \hat{x} 604 and/or the training input 602, generally include multiple tokens. For instance, the training input 602 includes the tokens 602-1 through 602-4. The trainer 600 converts a single training input (e.g., the training input 602) into multiple training inputs. For example, by removing the token 602-4, the blank 602-5 shifts left as the training input 602 calls for the trainer 600 to predict the token 602-4, thus creating a new training input from the original training input 602. As the value for the token 602-4 is known in this example, the new input is a labeled input, which allows it to be used by a supervised ML training algorithm (it should be noted that such an input is also able to be used by an unsupervised ML training algorithm). In this way, a single text containing multiple tokens (e.g., a book, a research paper, etc.) is used as multiple training inputs for the trainer 600.

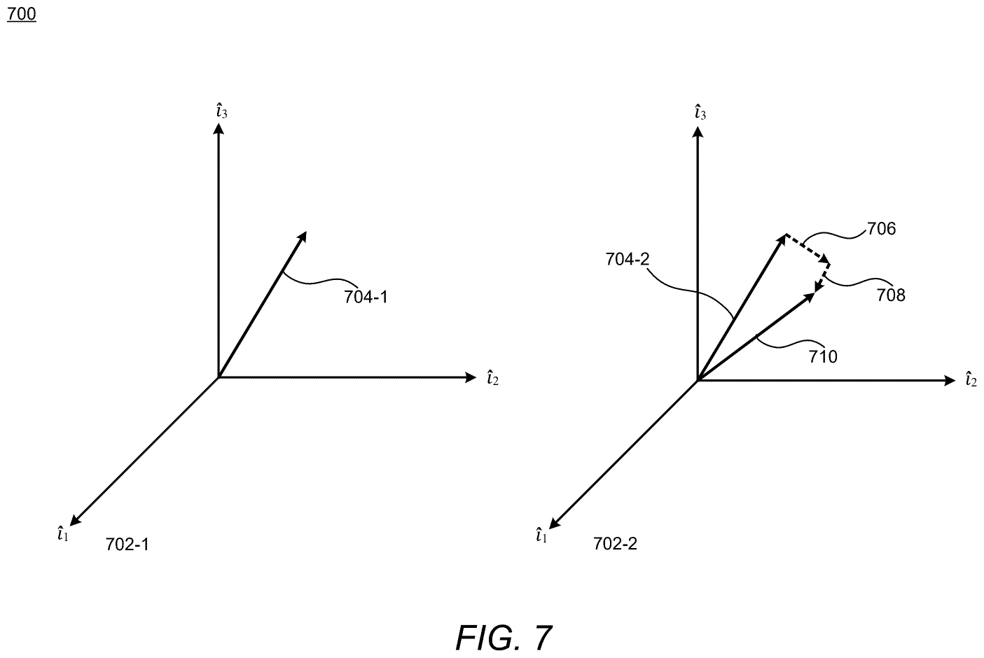

FIG. 7 illustrates an example transformation 700 in a language space 702-1 of an input tensor component 704-1 (e.g., the component 1204-1 of the input tensor \hat{x} 1204 of FIG. 12). The language space 702-1 is a multi-dimensional mathematical space, which includes specific language components codified as tensors within the multi-dimensional mathematical space. The term “tensor” is used herein as a mathematical object of any dimensionality, including scalar, vector, and matrix quantities. The language space 702-1 is therefore a mathematical vocabulary, and mapped tokens (e.g., token 1202-1 of FIG. 12) are tokens that have been translated into the mathematical vocabulary. For ease of illustration, the language space 702-1 is shown in FIG. 7 as a three-dimensional space with orthogonal basis vectors \hat{l}₁, \hat{l}₂, and \hat{l}₃. However, this should not be seen as limiting. In general, the language space 702-1 has the dimensionality of the mapped tokens from an input tensor. For example, the input tensor \hat{x} 1204 of FIG. 12, whose tensor components 1204-1 through 1204-4 each contain n members, corresponds to an n-dimensional language space.

The input tensor component 704-1 is plotted in the language space 702-1, shown in FIG. 7 as a vector in three-dimensional space. In some examples, the plotting is the product of a lookup table, a CNN feature mapping, or any other mapping from the token into the language space 702-1. The input tensor component 704-1 is transformed by the transformation 700. Consider a language space 702-2, identical to the language space 702-1, and an input tensor component 704-2, identical to the input tensor component 704-1. The transformation 700 is based on transformation operators 706 and 708 and performed by a transformer (e.g., the transformer 1300 of FIG. 13). The transformation operators 706 and 708 are illustrated as vector addition operators, resulting in a remapped tensor 710.

As an illustration of this transformation, let the input tensor component 704-2 represent a mapped (e.g., translated into the mathematical vocabulary of the language space 702-2) token of “temperature” and let the transformation operators 706 and 708 be generated by contextualizing mapped tokens “cool” and “three” from an input prompt, which includes the phrase “cool the temperature by three degrees.” Contextualizing is defined as characterizing the correlations between “temperature,” “cool,” and “three” from the input prompt (e.g., the input 602 of FIG. 6) in a way that corresponds with how a speaker of the input prompt's language would understand the word “temperature” as it appears in the input prompt along with “cool” and “three.” In this illustration, the transformed tensor 710 maps to an area of the language space 702-2 containing the token for a temperature-adjusting UI state.

Though the transformation of the input tensor component 704-2 to the transformed tensor 710 has been shown as two transformations using the transformation operators 706 and 708, this should not be seen as limiting. Any number of transformation operations may be employed, including more than two or a single transformation operation. Transformation operators (e.g., the transformation operator 706) may also take forms other than vector/tensor addition, such as multiplication (e.g., scaling, matrix multiplication, dot product, cross product, tensor product, etc.), normalization, orthogonalization, or any combination of these or other transformation operations known to a person of ordinary skill in the art. Thus, the transformation operators 706 and 708 of FIG. 7 are meant to be illustrative, not limiting.

### Example Methods

This section illustrates example methods, which may operate separately or together in whole or in part. Various example methods are described, each set forth in a subsection for ease of reading; these subsection titles are not intended to limit the interoperability of each of these methods one with the other.

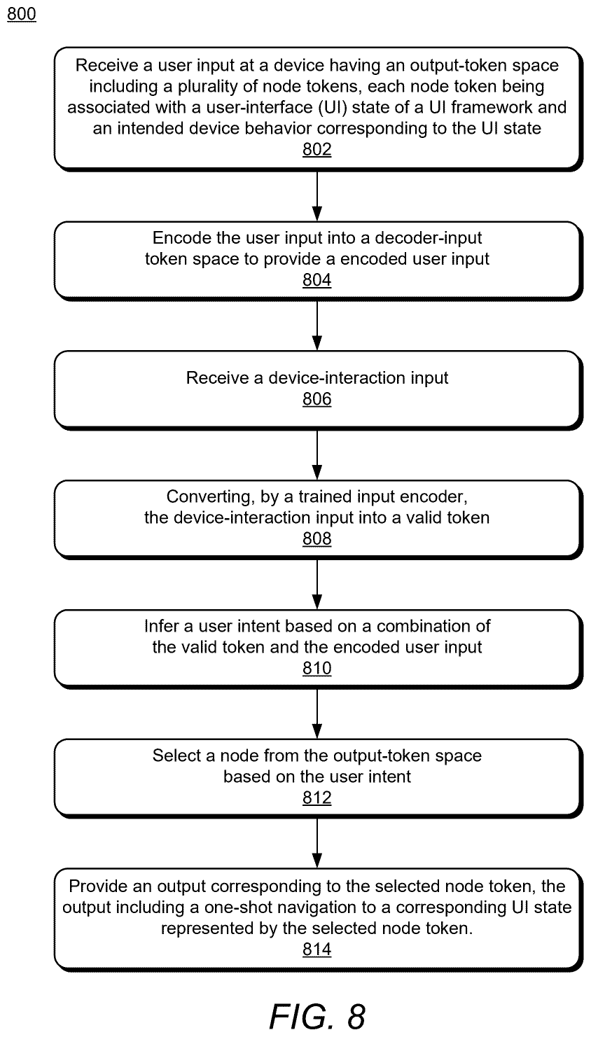

FIG. 8 depicts an example method 800 for implementing aspects of a UI navigator. The method 800 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example implementation 100 of FIG. 1 or to entities or processes as detailed in other figures, reference to which is made for example only. The techniques are not limited to performance by one entity or multiple entities operating on one device.

At 802, a user input is received at a device including an output-token space having a plurality of node tokens, each node token being associated with a user-interface (UI) state of a UI framework and an intended device behavior corresponding to the UI state. The user input may be a voice command. The user input may be received from another device and includes text input provided by a user via the other device. For example, the device may include memory or storage that stores data at least partially representing the output-token space. In some examples, the output-token space may be partially represented by data stored on devices external to the device (e.g., a server) but in network communication with the device.

At 804, the user input is encoded into a decoder-input token space to provide a encoded user input. The user input may be encoded and tokenized by a speech-to-text (STT) module.

At 806, a device-interaction input is received. The device-interaction input may be time synchronized with the user input. The device-interaction input may be a second user input received via a mechanical input device integrated with the device. The device-interaction input may include a turn of rotary dial of the device.

At 808, the device-interaction input is converted, by a trained input decoder, into a valid token. In an example, the trained input decoder (e.g., the transformer decoder 506, the LAM 110) can combine the valid token with the tokenized user input to infer user intent. In aspects, the transformer decoder 506 is stored and executed on the device (e.g., the computing device 102), at one or more external devices (e.g., server) that is in network communication with the device, or a combination of the device and the one or more external devices.

At 810, a user intent is inferred based on a combination of the valid token and the decoded user input. For example, the transformer decoder 506 infers a user-intended destination within the UI framework 104 based on the combination of inputs.

At 812, a node is selected from the output-token space based on a combination of the valid token and the decoded user input. For example, the transformer decoder 506 is constrained to select one of the nodes in the output-token space based on the input(s).

At 814, an output corresponding to the selected node token is provided, the output including a one-shot navigation to a corresponding UI state represented by the selected node token. The output of the decoder may include a null state and responsive to the decoder selecting the null state, a clarifying prompt may be generated to request additional information from the user regarding the inferred user intent. Further, based on receiving an additional user input, a second node token may be selected from the output-token space and the output may be adjusted to provide another function of another UI state corresponding to the second node token.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although concepts of a UI navigator have been described in language specific to techniques and/or apparatuses, it is to be understood that the subject of the appended claims is not necessarily limited to the specific techniques or apparatuses described. Rather, the specific techniques and apparatuses are disclosed as example implementations of ways the UI navigator may be implemented.

1. A method comprising:
receiving a user input at a device including an output-token space including a plurality of node tokens, each node token being associated with a user-interface (UI) state of a UI framework and an intended device behavior corresponding to the UI state;
encoding the user input into a decoder-input token space to provide an encoded user input;
receiving a device-interaction input;
converting, by a trained input encoder, the device-interaction input into a valid token;
inferring a user intent based on a combination of the valid token and the encoded user input;
selecting a node from the output-token space based on the inferred user intent; and
providing an output corresponding to the selected node token, the output including a one-shot declaration of a function of a corresponding UI state represented by the selected node token.

2. The method of claim 1, wherein the user input is a voice command.

3. The method of claim 1, wherein the user input is received from a remote device and includes text input provided by a user via the remote device.

4. The method of claim 1, wherein the user input is encoded and tokenized by a speech-to-text module.

5. The method of claim 1, further comprising time synchronizing the device-interaction input with the user input.

6. The method of claim 1, wherein the device-interaction input is a second user input received via a mechanical input device integrated with the device.

7. The method of claim 6, wherein the device-interaction input includes a turn of rotary dial of the device.

8. The method of claim 1, wherein the output includes a null state, and the method further comprises:
generating, responsive to selecting the null state, a prompt to request additional information from a user regarding the user intent;
selecting, based on receiving an additional user input, a second node token from the output-token space; and
adjusting the output to provide another function of another UI state corresponding to the second node token.

9. A computing device comprising:
a user interface (UI) framework having a plurality of UI states;
an output-token space including a plurality of node tokens, each node token being associated with a UI state of the plurality of UI states and an intended device behavior corresponding to the UI state; and
a UI navigator configured to:
receive a user input;
encode the user input into a decoder-input token space to provide an encoded user input;
receive a device-interaction input;
convert the device-interaction input into a valid token;
infer a user intent based on a combination of the valid token and the encoded user input;
select a node from the output-token space based on the inferred user intent; and
provide an output corresponding to the selected node token, the output including a one-shot declaration of a function of a corresponding UI state represented by the selected node token.

10. The computing device of claim 9, wherein the user input is a voice command.

11. The computing device of claim 9, wherein the user input is received from a remote device and includes text input provided by a user via the remote device.

12. The computing device of claim 9, the UI navigator comprises a speech-to-text module configured to encode and tokenize the user input.

13. The computing device of claim 9, wherein the UI navigator is further configured to time synchronize the device-interaction input with the user input.

14. The computing device of claim 9, wherein the device-interaction input is a second user input received via a mechanical input device integrated with the computing device.

15. The computing device of claim 14, wherein the device-interaction input includes a turn of rotary dial of the computing device.

16. The computing device of claim 9, wherein the output includes a null state, and the UI navigator is further configured to:
generate, responsive to selection of the null state, a prompt to request additional information from a user regarding the user intent;
select, based on an additional user input, a second node token from the output-token space; and
adjust the output to provide another function of another UI state corresponding to the second node token.

17. One or more computer-readable storage media storing instructions that, responsive to execution by one or more processors, cause the one or more processors to perform operations including:
receiving a user input at a device including an output-token space including a plurality of node tokens, each node token being associated with a user-interface (UI) state of a UI framework and an intended device behavior corresponding to the UI state;
encoding the user input into a decoder-input token space to provide an encoded user input;
receiving a device-interaction input;
converting, by a trained input encoder, the device-interaction input into a valid token;
inferring a user intent based on a combination of the valid token and the encoded user input;
selecting a node from the output-token space based on the inferred user intent; and
providing an output corresponding to the selected node token, the output including a one-shot declaration of a function of a corresponding UI state represented by the selected node token.

18. The one or more computer-readable storage media of claim 17, wherein the user input is a voice command and the device-interaction input is a second user input received via a mechanical input device integrated with the device.

19. The one or more computer-readable storage media of claim 18, wherein the device-interaction input includes a turn of rotary dial of the device.

20. The one or more computer-readable storage media of claim 16, wherein the user input is received from a remote device and includes text input provided by a user via the remote device.
